(19) United States
(12) Patent Application Publication
(10) Pub. No.: US 2008/0214703 A1
(43) Pub. Date: Sep. 4, 2008

(54) Pellet and fiber length for polyester fiber reinforced polypropylene composites

(76) Inventors: Amold Lustiger, Edison, NJ (US); Walter T. Matuszek, Easton, PA (US)

Correspondence Address: ExxonMobil Research and Engineering Company, P.O.Box 900, Annandale, NJ, 08801-0900, US

(21) Appl. No.: 12/074,928

(22) Filed: Mar. 7, 2008

Related U.S. Application Data
(63) Continuation-in-part of application No. 11/301,533, filed on Dec. 13, 2005.
(60) Provisional application No. 60/906,041, filed on Mar. 9, 2007.

(51) Int. Cl. C08K 3/00; C08L 23/12; C08K 3/26; C08K 3/22; C08K 3/30; C08K 3/34; C08K 5/00; C08K 5/09

(52) U.S. Cl. 524/35; 524/502; 524/451; 524/427; 524/433; 524/423; 524/449; 524/456; 524/445; 524/447; 524/430; 524/424; 524/413; 524/432; 524/284

(57) ABSTRACT

The present disclosure is directed generally to polyester fiber reinforced polypropylene resin pellets and methods for producing therein. The polyester fiber reinforced polypropylene resin pellets include at least 25 wt % polypropylene based polymer; from 10 to 40 wt % polyester fiber; from 0 to 60 wt % inorganic filler; and from 0 to 0.2 wt % lubricant. The polyester fiber is incorporated into the resin pellets by feeding chopped fiber or continuous fiber unwound from one or more spools. Articles molded from the polyester fiber reinforced polypropylene resin pellets exhibit a drop dart impact resistance that is dependent on the pellet length and whether the PET fiber is incorporated as chopped fiber or continuous fiber during the extrusion compounding process. Articles molded from the polyester fiber reinforced polypropylene resin pellets find application as automotive parts, household appliance parts, or boat hulls.

This application claims the benefit of U.S. Provisional Application 60/906,041 filed Mar. 9, 2007 and is a Continuation-in-Part of U.S. application Ser. No. 11/301,533 filed Dec. 13, 2005.

### FIELD

The present disclosure is directed generally to fiber reinforced polypropylene compositions and articles made from such compositions having a flexural modulus of at least 300,000 psi and exhibiting ductility during instrumented impact testing. It more particularly relates to polyester fiber reinforced polypropylene resin pellets yielding articles with improved drop dart impact strength, and methods of producing such pellets.

### BACKGROUND

Polyolefins have limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced which address toughness. For example, it is known to increase the toughness of polypropylene by adding rubber particles, either in-reactor resulting in impact copolymers, or through post-reactor blending. However, while toughness is improved, the stiffness is considerably reduced using this approach.

Glass reinforced polypropylene compositions have been introduced to improve stiffness. However, the glass fibers have a tendency to break in typical injection molding equipment, resulting in reduced toughness and stiffness. In addition, glass reinforced products have a tendency to warp after injection molding.

Another known method of improving physical properties of polyolefins is organic fiber reinforcement. For example, EP Patent Application 0397881, the entire disclosure of which is hereby incorporated herein by reference, discloses a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the entire disclosure of which is hereby incorporated herein by reference, discloses a composition including a polymer, such as polypropylene, and uniformly dispersed therein at least about 10% by weight of the composition staple length fiber, the fiber being of man-made polymers, such as poly(ethylene terephthalate) or poly(1,4-cyclohexylenedimethylene terephthalate).

Fiber reinforced polypropylene compositions are also disclosed in PCT Publication WO02/053629, the entire disclosure of which is hereby incorporated herein by reference. More specifically, WO02/053629 discloses a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

U.S. Pat. No. 3,304,282 to Cadus et al. discloses a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent discloses an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. discloses a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. discloses an impregnation process for preparing pellets of a synthetic organic fiber reinforced polyolefin. The process comprises the steps of heating a polyolefin at the temperature which is higher than the melting point thereof by 40 degree C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. discloses a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

The above referenced patent publications and applications have not investigated the relationship between fiber reinforced resin pellet length, cut fiber length and the resultant impact properties of articles molded from such pellets. Because pellet length may impact the average fiber length and fiber length distribution, a need exists to determine if such a relationship exists and if so, to determine the resultant effect on impact resistance of parts molded from the fiber reinforced polypropylene composite resin.

### SUMMARY

It has surprisingly been found that the pellet length of PET fiber reinforced polypropylene resins has a substantial effect on the impact resistance of articles molded from such resins. In addition, the input fiber length of the chopped PET fiber used to produce PET fiber reinforced polypropylene resins also has a substantial effect on the impact resistance of articles molded from such resins. It has also been surprisingly found that the advantageous pellet length for such composites varies as a function of whether chopped PET fiber or PET in the form spools of fiber continuously unwound into the hopper of the compounding extruder is utilized to produce such resin pellets. The PET fiber reinforced polypropylene resin pellets of the present disclosure are particularly suitable for making molded articles including, but not limited to, household appliances, automotive parts, and boat hulls.

One aspect of the present disclosure provides PET fiber reinforced polypropylene resin pellets comprising, based on the total weight of the composition, at least 25 wt % polypropylene based polymer; from 20 to 40 wt % polyester fiber; from 0 to 60 wt % inorganic filler; and from 0 to 0.2 wt % lubricant; wherein the resin pellets range from 3.2 to 12.7 mm in length, wherein the polyester fiber is incorporated into the resin pellets by continuously feeding PET fiber from one or more spools into the extruder hopper of a compounding extruder, and wherein an article molded from the resin pellets exhibits a drop dart impact resistance of at least 5.3 newton meter.

Another aspect of the present disclosure provides PET fiber reinforced polypropylene resin pellets comprising, based on the total weight of the composition, at least 25 wt % polypropylene based polymer; from 20 to 40 wt % polyester fiber; from 0 to 60 wt % inorganic filler; and from 0 to 0.2 wt % lubricant; wherein the resin pellets range from 3.2 to 19.1 mm in length, wherein the polyester fiber is incorporated into the resin pellets by feeding chopped PET fiber into a compounding extruder, and wherein an article molded from the resin pellets exhibits a drop dart impact resistance of at least 6.1 newton meter.

Another aspect of the present disclosure provides a method of making PET fiber reinforced polypropylene resin pellets comprising, based on the total weight of the composition, at least 25 wt % polypropylene based polymer; from 20 to 40 wt % polyester fiber; from 0 to 60 wt % inorganic filler; and from 0 to 0.2 wt % lubricant; wherein the resin pellets range from 3.2 to 12.7 mm in length, wherein the polyester fiber is incorporated into the resin pellets by continuously feeding PET fiber from one or more spools into the extruder hopper of a compounding extruder, and wherein an article molded from the resin pellets exhibits a drop dart impact resistance of at least 5.3 newton meter; wherein the method comprises feeding into the extruder the polypropylene based resin, the polyester fiber, the inorganic filler, and the lubricant; extruding the polypropylene based resin, the PET fiber, the inorganic filler and the lubricant through the extruder to form a PET fiber reinforced polypropylene composite melt; cooling and pelletizing the PET fiber reinforced polypropylene composite melt to form the PET fiber reinforced polypropylene resin pellets.

Still another aspect of the present disclosure provides a method of making PET fiber reinforced polypropylene resin pellets comprising, based on the total weight of the composition, at least 25 wt % polypropylene based polymer; from 20 to 40 wt % polyester fiber; from 0 to 60 wt % inorganic filler; and from 0 to 0.2 wt % lubricant; wherein the resin pellets range from 3.2 to 19.1 mm in length, wherein the polyester fiber is incorporated into the resin pellets by feeding chopped PET fiber into a compounding extruder, and wherein an article molded from the resin pellets exhibits a drop dart impact resistance of at least 6.1 newton meter; wherein the method comprises feeding into the extruder the polypropylene based resin, the polyester fiber, the inorganic filler, and the lubricant; extruding the polypropylene based resin, the PET fiber, the inorganic filler and the lubricant through the extruder to form a PET fiber reinforced polypropylene composite melt; cooling and pelletizing the PET fiber reinforced polypropylene composite melt to form the PET fiber reinforced polypropylene resin pellets.

Still another aspect of the present disclosure provides PET fiber reinforced polypropylene resin pellets comprising, based on the total weight of the composition, at least 25 wt % polypropylene based polymer; from 20 to 40 wt % polyester fiber, wherein the polyester fiber denier is less than 5; from 0 to 60 wt % inorganic filler; and from 0 to 0.2 wt % lubricant; wherein the resin pellets range from 3.2 to 25.4 mm in length, and wherein an article molded from the resin pellets exhibits a drop dart impact resistance of at least 5.0 newton meter.

Still yet another aspect of the present disclosure provides a method of making PET fiber reinforced polypropylene resin pellets comprising, based on the total weight of the composition, at least 25 wt % polypropylene based polymer; from 20 to 40 wt % polyester fiber, wherein the polyester fiber denier is less than 5; from 0 to 60 wt % inorganic filler; and from 0 to 0.2 wt % lubricant; wherein the resin pellets range from 3.2 to 25.4 mm in length, and wherein an article molded from the resin pellets exhibits a drop dart impact resistance of at least 5.0 newton meter; wherein the method comprises: feeding into the extruder the polypropylene based resin, the polyester fiber, the inorganic filler, and the lubricant; extruding the polypropylene based resin, the PET fiber, the inorganic filler and the lubricant through the extruder to form a PET fiber reinforced polypropylene composite melt; cooling and pelletizing the PET fiber reinforced polypropylene composite melt to form the PET fiber reinforced polypropylene resin pellets.

These and other features and attributes of the disclosed PET fiber reinforced polypropylene resin pellets and method of making therein and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 depicts one form of the process for making PET fiber reinforced polypropylene composite resin pellets of the present disclosure using continuous PET fiber fed from spools.

FIG. 2 depicts another form of a twin screw extruder with a downstream feed port for making PET fiber reinforced polypropylene composite resin pellets of the present disclosure using chopped PET fiber fed into the downstream feed port.

FIG. 3 depicts an exemplary schematic of a twin screw extruder screw configuration for making PET fiber reinforced polypropylene composite resin pellets of the present disclosure.

### DETAILED DESCRIPTION

The present disclosure relates to improved PET fiber reinforced polypropylene composite resin pellets and methods of making therein. The PET fiber reinforced polypropylene resin pellets of the present disclosure are distinguishable over the prior art in comprising a combination of a polypropylene based matrix with PET fiber and inorganic filler in a resin pellet length that is advantageous as to impact resistance of articles molded from said resin pellets. The PET reinforced polypropylene resin pellets yield articles molded from the pellets with a drop dart impact resistance of at least 5.0 newton meter and do not splinter upon impact testing. The PET fiber reinforced polypropylene composite resin pellets of the present disclosure are also distinguishable over the prior art in comprising a polypropylene based matrix polymer with an advantageous high melt flow rate without sacrificing impact resistance. In addition, PET fiber reinforced polypropylene composite resin pellets of the present disclosure do not splinter during instrumented impact testing. The process of making PET fiber reinforced polypropylene compositions of the present disclosure are also distinguishable over the prior art in providing a process that controls and optimizes the resin pellet length and the input cut PET fiber length and thickness for impact resistance. All numerical values within the detailed description and the claims herein are understood as modified by “about.”

U.S. patent application Ser. No. 11/301,533 filed on Dec. 13, 2005, herein incorporated by reference in its entirety, discloses advantageous fiber reinforced polypropylene compositions. The fiber reinforced polypropylene compositions include at least 25 wt % polypropylene based polymer, from 5 to 60 wt % organic fiber, and from 0 to 60 wt % inorganic filler. Articles molded from these fiber reinforced polypropylene compositions have a flexural modulus of at least 300,000 psi, and exhibit ductility during instrumented impact testing.

U.S. patent application Ser. No. 11/318,363 filed on Dec. 23, 2005, herein incorporated by reference in its entirety, discloses advantageous processes for making fiber reinforced polypropylene resins including at least 25 wt % polypropylene based polymer, from 5 to 60 wt % organic fiber, and from 0 to 60 wt % inorganic filler. The process includes extrusion compounding the polypropylene based polymer, the organic fiber, and the inorganic filler to form a fiber reinforced polypropylene resin pellets, which are subsequently molded to form an article with a flexural modulus of at least 300,000 psi, and that exhibits ductility during instrumented impact testing.

U.S. patent application Ser. No. 11/395,493 filed on Mar. 31, 2006, herein incorporated by reference in its entirety, discloses cloth-like fiber reinforced polypropylene compositions, and the beneficial mechanical and aesthetic properties imparted by such compositions. The cloth-like fiber reinforced polypropylene compositions include at least 25 wt % polypropylene based polymer, from 5 to 60 wt % organic reinforcing fiber, from 0 to 60 wt % inorganic filler, and from 0.1 to 2.5 wt % colorant fiber. Articles molded from these fiber reinforced polypropylene compositions have a flexural modulus of at least 300,000 psi, exhibit ductility during instrumented impact testing, and exhibit a cloth-like appearance.

The PET fiber reinforced polypropylene composite resin pellets of the present disclosure simultaneously have desirable stiffness, as measured by having a flexural modulus of at least 300,000 psi, and toughness, as measured by exhibiting ductility during instrumented impact testing. In addition, PET fiber reinforced polypropylene composite resin pellets of the present disclosure with particular pellet lengths yield articles with drop dart impact resistance values exceeding 5.0, or 6.0, or 7.0, or 8.0, or 9.0, or 10.0, or 11.0, or 12.0, or 13.0 newton meter. In a particular embodiment, the PET reinforced polypropylene resin pellets after molding yield an article having a flexural modulus of at least 350,000 psi, or at least 370,000 psi, or at least 390,000 psi, or at least 400,000 psi, or at least 450,000 psi. Still more particularly, the PET reinforced polypropylene resin pellets after molding yield have a flexural modulus of at least 600,000 psi, or at least 800,000 psi. It is also believed that having a weak interface between the polypropylene matrix and the PET fiber contributes to fiber pullout; and, therefore, may enhance toughness. Thus, there is no need to add modified polypropylenes to enhance bonding between the PET fiber and the polypropylene matrix, although the use of modified polypropylene may be advantageous to enhance the bonding between a filler, such as talc or wollastonite and the matrix polymer. In addition, in one embodiment, there is no need to add lubricant to weaken the interface between the polypropylene and the fiber to further enhance fiber pullout. Some embodiments also display no splintering during instrumented dart impact testing, which yield a further advantage of not subjecting a person in close proximity to the impact to potentially harmful splintered fragments. This characteristic is advantageous in automotive applications.

Compositions of the present disclosure generally include at least 25 wt %, based on the total weight of the composition, of polypropylene based polymer as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 60 wt %, or 75 wt %, or 80 wt %, based on the total weight of the composition. In another embodiment, the polypropylene is present in an amount of at least 25 wt %.

The polypropylene based resin used as the matrix resin is not particularly restricted and is generally selected from the group consisting of propylene homopolymers, propylene-ethylene random copolymers, propylene-butene-1 random copolymers, propylene-hexene-1 random copolymers, propylene-octene-1 random copolymers, other propylene-α-olefin random copolymers, propylene block copolymers, propylene impact copolymers, ethylene-propylene-butene-1 terpolymers and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene base resin of the matrix resin may have a melt flow rate of from 20 to 1500 g/10 min. In a particular embodiment, the melt flow rate of the polypropylene matrix resin is greater 100 g/10 min, and still more particularly greater than or equal to 400 g/10 min. In yet another embodiment, the melt flow rate of the polypropylene matrix resin is 1500 g/10 min. The higher melt flow rate permits for improvements in processability, throughput rates, and higher loading levels of organic fiber and inorganic filler without negatively impacting flexural modulus and impact resistance.

In a particular embodiment, the matrix polypropylene may contain less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from 0.1 wt % to less than 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polypropylene matrix is generally from 0.5 wt % or 2.5 wt % to 7.5 wt % or 10 wt %, based on the total weight of the matrix. Diffusion of additive(s) during processing may cause a portion of the additive(s) to be present in the fiber.

The polypropylene matrix resin of the present disclosure is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the disclosure is not limited to any particular catalyst for making the polypropylene, and may, for example, include Ziegler-Natta or metallocene catalysts.

The fiber reinforced polypropylene resin pellets disclosed herein generally include at least 5 wt %, based on the total weight of the composition, of an organic fiber. In a particular embodiment, the fiber is present in an amount of at least 10 wt %, or at least 15 wt %, or at least 20 wt %, or in an amount within the range having a lower limit of 10 wt %, or 15 wt %, or 20 wt %, or 25 wt %, and an upper limit of 25 wt %, or 30 wt %, or 40 wt %, or 50 wt %, or 55 wt %, or 60 wt %, or 70 wt %, based on the total weight of the composition. In another embodiment, the PET fiber is present in an amount of at least 10 wt % and up to 40 wt %. In yet another embodiment, PET fiber is present in an amount of at least 20 wt % and up to 40 wt %. In order to improve the impact resistance, organic fibers are also referred to as reinforcing fibers and are incorporated into the polypropylene based polymer matrix.

The polymer used as the fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another embodiment, PET fiber is advantageous in yielding PET fiber reinforced polypropylene resin pellets with drop dart impact resistance values of at least 5.0 newton meter and exhibiting no splintering upon drop dart impact testing over a range of pellet lengths of 3.2 to 25.4 mm. In another particular embodiment, PET fiber is advantageous in yielding PET fiber reinforced polypropylene resin pellets with drop dart impact resistance values of at least 5.3 newton meter over a range of pellet lengths ranging from 3.2 to 12.7 mm. In yet another particular embodiment, PET fiber in the form of continuous fiber fed to the compounding extruder is advantageous in yielding PET fiber reinforced polypropylene resin pellets with drop dart impact resistance values of at least 7.9 newton meter over a range of pellet lengths ranging from 6.4 to 9.5 mm. In still yet another particular embodiment, PET fiber in the form of 6.4 mm long chopped fiber is advantageous in yielding PET fiber reinforced polypropylene resin pellets with drop dart impact resistance values of at least 6.4 newton meter over a range of pellet lengths ranging from 9.5 to 12.7 mm.

In one embodiment, the fiber is a single component fiber. In another embodiment, the fiber is a multicomponent fiber wherein the fiber is formed from a process wherein at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the organic fibers of the present disclosure are not particularly restricted. The length of the PET cut fiber within the meaning of this disclosure is with respect to the input length of the cut or chopped PET fiber being fed to the compounding extruder or other mixing apparatus. This is also referred to within the detailed description and the claims of the present disclosure as the “input chopped polyester fiber length” or the “input cut polyester fiber length.” The length of the cut or chopped PET fiber referred to within the detailed description and the claims is not with respect to the length of the PET fiber within the pellets after compounding. It is understood that during the extrusion compounding process, the input chopped or cut PET fiber may undergo further length reduction through the process. In a particular embodiment, the input PET cut or chopped fibers may have a length of 6.4 mm, or a length within the range of 3.2 to 25.4 mm, or more particularly a length within the range of 4.8 to 12.7 mm. In another embodiment, the input PET cut fibers may have a length of 3.2 to 19.1 mm, or 6.4 to 12.7 mm. In another embodiment, the input PET cut fiber length may be 3.2 mm, or 6.4 mm, or 12.7 mm, or 19.1 mm, or 25.4 mm.

The diameter or denier of the organic fiber within the meaning of this disclosure is also with respect to the input diameter or denier of the organic fiber being fed to the compounding extruder or other mixing apparatus. Denier is defined as grams of fiber per 9000 meters of fiber length. This is also referred to within the detailed description and the claims of the present disclosure as the “input polyester fiber denier” or the “input polyester fiber diameter.” The diameter or denier of the PET fiber referred to within the detailed description and the claims is not with respect to the diameter of the PET fiber within the pellets after compounding. It is understood that during the extrusion compounding process, the input PET fiber may undergo a change in denier or diameter due to shrinkage or expansion through the process. Denier may be related to fiber diameter for a given fiber type (fiber density).

The diameter of the organic fiber may be within the range having a lower limit of 5 μm and an upper limit of 100 μm. In a particular embodiment, the PET fibers have a diameter of from 25 to 35 μm (6 to 12 denier), or more particularly a diameter of from 25 to 30 μm (6 to 9 denier). In another embodiment, the input PET fiber may range from 5 to 15 denier. In another embodiment, the input PET fiber diameter ranges from 15 to 35 μm. In yet another embodiment, the PET fiber diameter is less than 15 microns. In another embodiment, the PET fiber denier is less than 5, or less than 4, or less than 3.2, or less than 2. In still yet another embodiment, the PET fiber denier is 3.1 (also referred to herein as low denier PET fiber). As the PET fiber denier or diameter decreases, generally increased loadings are needed in the PP/PET composite to maintain impact resistance constant.

The organic fiber may further contain additives commonly known in the art. For example, PET fiber may include additives, such as dispersant, lubricant, flame-retardant, antioxidant, antistatic agent, light stabilizer, ultraviolet light absorber, carbon black, nucleating agent, plasticizer, and coloring agent such as dye or pigment.

The organic fiber used to make the compositions of the present disclosure is not limited by any particular fiber form. For example, the PET fiber may be in the form of continuous filament yarn, partially oriented yarn, or staple fiber. In another embodiment, the fiber may be a continuous multifilament fiber or a continuous monofilament fiber.

In another embodiment of the PET fiber reinforced polypropylene resin pellets disclosed herein, the PET fiber reinforced polypropylene compositions further include from 0.01 to 0.2 wt %, or more particularly from 0.05 to 0.1 wt % lubricant, based on the total weight of the composition. Suitable lubricants include, but are not limited to, silicon oil, silicon gum, fatty amide, paraffin oil, paraffin wax, ester oil, and combinations thereof. Lubricant incorporation may assist with the pull-out of organic fiber from the polypropylene based matrix polymer to further improve impact resistance.

In another exemplary embodiment of the present disclosure, the PET fiber reinforced polypropylene resin pellets may be made cloth-like in terms of appearance, feel, or a combination thereof. Cloth-like appearance or look is defined as having a uniform short fiber type of surface appearance. Cloth-like feel is defined as having a textured surface or fabric type feel. The incorporation of the colorant fiber into the fiber reinforced polypropylene composition results in a cloth-like appearance. When the fiber reinforced polypropylene composition is processed through a mold with a textured surface, a cloth-like feel is also imparted to the surface of the resulting molded part.

Cloth-like PET fiber reinforced polypropylene resin pellets of the present disclosure generally include from 0.1 to 2.5 wt %, based on the total weight of the composition, of a colorant fiber. Still more advantageously, the colorant fiber is present from 0.5 to 1.5 wt %, based on the total weight of the composition. Even still more advantageously, the colorant fiber is present at less than 1.0 wt %, based on the total weight of the composition.

The colorant fiber type is not particularly restricted and is generally selected from the group consisting of cellulosic fiber, acrylic fiber, nylon fiber or polyester type fiber. Polyester type fibers include, but are not limited to, polyethylene terephlalate, polybutylene terephalate, and polyethylene naphthalate. Polyamide type fibers include, but are not limited to, nylon 6, nylon 6,6, nylon 4,6 and nylon 6,12. In a particular embodiment, the colorant fiber is cellulosic fiber, also commonly referred to as rayon. In another particular embodiment, the colorant fiber is a nylon type fiber.

The colorant fiber used to make the PET fiber reinforced polypropylene resin pellets disclosed herein is not limited by any particular fiber form prior to being chopped for incorporation into the fiber reinforced polypropylene composition. For example, the colorant fiber may be in the form of continuous filament yarn, partially oriented yarn, or staple fiber. In another embodiment, the colorant fiber may be a continuous multifilament fiber or a continuous monofilament fiber.

The length and diameter of the colorant fiber may be varied to alter the cloth-like appearance in the molded article. The length and diameter of the colorant fiber of the present disclosure is not particularly restricted. In a particular embodiment, the input colorant fibers to the compounding process have a length of less than 6.4 mm, or advantageously a length of between 0.8 to 3.2 mm. In another particular embodiment, the diameter of the input colorant fibers to the compounding process is within the range having a lower limit of 10 μm and an upper limit of 100 μm.

The colorant fiber is colored with a coloring agent, which comprises either inorganic pigments, organic dyes or a combination thereof. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Exemplary pigments and dyes incorporated into the colorant fiber include, but are not limited to, phthalocyanine, azo, condensed azo, azo lake, anthraquinone, perylene/perinone, indigo/thioindigo, isoindolinone, azomethineazo, dioxazine, quinacridone, aniline black, triphenylmethane, carbon black, titanium oxide, iron oxide, iron hydroxide, chrome oxide, spinel-form calcination type, chromic acid, talc, chrome vermilion, iron blue, aluminum powder and bronze powder pigments. These pigments may be provided in any form or may be subjected in advance to various dispersion treatments in a manner known per se in the art. Depending on the material to be colored, the coloring agent can be added with one or more of various additives such as organic solvents, resins, flame retardants, antioxidants, ultraviolet absorbers, plasticizers and surfactants.

The base fiber reinforced polypropylene base composite material that the colorant fiber is incorporated into may also be colored using the inorganic pigments, organic dyes or combinations thereof. Exemplary pigments and dyes for the base fiber reinforced polypropylene composite material may be of the same types as indicated in the preceding paragraph for the colorant fiber. Typically the base fiber reinforced polypropylene composite material is made of a different color or a different shade of color than the colorant fiber, such as to create a cloth-like appearance upon uniformly dispersing the short colorant fibers in the colored base fiber reinforced polypropylene composite material. In one particular exemplary embodiment, the base fiber reinforced polypropylene composite material is light grey in color and the colorant fiber is dark grey or blue in color to create a cloth-like look from the addition of the short colorant fiber uniformly dispersed through the base fiber reinforced polypropylene composite material.

The colorant fiber in the form of chopped fiber may be incorporated directly into the base fiber reinforced polypropylene composite material via the twin screw or single screw extrusion compounding process, or may be incorporated as part of a masterbatch resin to further facilitate the dispersion of the colorant fiber within the fiber reinforced polypropylene composite base material. When the colorant fiber is incorporated as part of a masterbatch resins, exemplary carrier resins include, but are not limited to, polypropylene homopolymer, ethylene-propylene copolymer, ethylene-propylene-butene-1 terpolymer, propylene-butene-1 copolymer, low density polyethylene, high density polyethylene, and linear low density polyethylene. In one exemplary embodiment, the colorant fiber is incorporated into the carrier resin at less than 25 wt %. The colorant fiber masterbatch is then incorporated into the fiber reinforced polypropylene composite base material at a loading of from 1 wt % to 10 wt %, or from 2 to 6 wt %. In a particularly advantageous embodiment, the colorant fiber masterbatch is added at 4 wt % based on the total weight of the composition. In another exemplary embodiment, a masterbatch of either black rayon or black nylon type fibers in linear low density polyethylene carrier resin is incorporated at a loading of 4 wt % in the fiber reinforced polypropylene composite base material.

The colorant fiber or colorant fiber masterbatch may be fed to the twin screw or single screw extrusion compounding process with a gravimetric feeder at either the feed hopper or at a downstream feed port in the barrel of the twin screw or single screw extruder. Kneading and mixing elements are incorporated into the twin screw or single screw extruder screw design downstream of the colorant fiber or colorant fiber masterbatch injection point, such as to uniformly disperse the colorant fiber within the cloth-like fiber reinforced polypropylene composite material.

Compositions of the present disclosure optionally include inorganic filler in an amount of at least 1 wt %, or at least 5 wt %, or at least 10 wt %, or in an amount within the range having a lower limit of 0 wt %, or 1 wt %, or 5 wt %, or 10 wt %, or 15 wt %, and an upper limit of 25 wt %, or 30 wt %, or 35 wt %, or 40 wt %, or 50 wt %, or 60 wt %, based on the total weight of the composition. In yet another embodiment, the inorganic filler may be included in the polypropylene fiber composite in the range of from 10 wt % to 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof. The talc may have a size of from 1 to 100 microns. In one particular embodiment, at a high talc loading of up to 60 wt %, the polypropylene fiber composite exhibited a flexural modulus of at least 750,000 psi and no splintering during instrumented impact testing (15 mph, −29° C., 25 lbs). In another particular embodiment, at a low talc loading of as low as 10 wt %, the polypropylene fiber composite exhibited a flexural modulus of at least 325,000 psi and no splintering during instrumented impact testing (15 mph, −29° C., 25 lbs). In addition, wollastonite loadings of from 10 wt % to 60 wt % in the polypropylene fiber composite yielded an outstanding combination of impact resistance and stiffness.

In another particular embodiment, a fiber reinforced polypropylene composite resin pellets including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of 140 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively.

In one exemplary embodiment where PET fiber is continuously unwound from spools into a twin screw or single screw extrusion compounding extruder hopper, the PET reinforced polypropylene resin pellets may range from 3.2 to 12.7 mm in length and more advantageously from 6.4 to 9.5 mm in length to yield drop dart impact resistance values of at least 7.9 newton meter. In another exemplary embodiment where ¼″ (6.4 mm in length) chopped PET fiber is fed via a feeder into a twin screw or single screw extrusion compounding extruder hopper, the PET reinforced polypropylene resin pellets may range from 3.2 to 12.7 mm in length, and more advantageously from 9.5 to 12.7 mm in length to yield drop dart impact resistance values of at least 6.4 newton meter. The drop dart impact resistance values are generally higher when chopped PET fiber is fed to the compounding extruder as opposed to continuous PET fiber from one or more spools.

The PET fiber reinforced polypropylene resin pellets disclosed herein are not limited by any particular method for forming the compositions. For example, the compositions can be formed by contacting polypropylene, organic fiber, and optional inorganic filler in any of the well known processes of pultrusion or extrusion compounding. In a particular embodiment, the compositions are formed in an extrusion compounding process (single screw or twin screw) or a batch type mixer when using input chopped organic fiber. In one advantageous process, PET fiber reinforced resin pellets are formed via a twin screw extrusion compounding process. In another advantageous process, PET fiber reinforced resin pellets are formed via a single screw extrusion compounding process. In a particular aspect of this embodiment, the PET fibers are cut (i.e. fed as chopped PET fiber or staple PET fiber) prior to being fed into the extruder hopper or fed to the extruder via a downstream feed port. In another particular aspect of this embodiment, the PET fibers are fed directly from one or more spools into the extruder hopper. The extrusion compounding process or pultrusion process form one or more strands of PET fiber reinforced polypropylene composites that are then cut through a pelletizing process into resin pellets of the desired length.

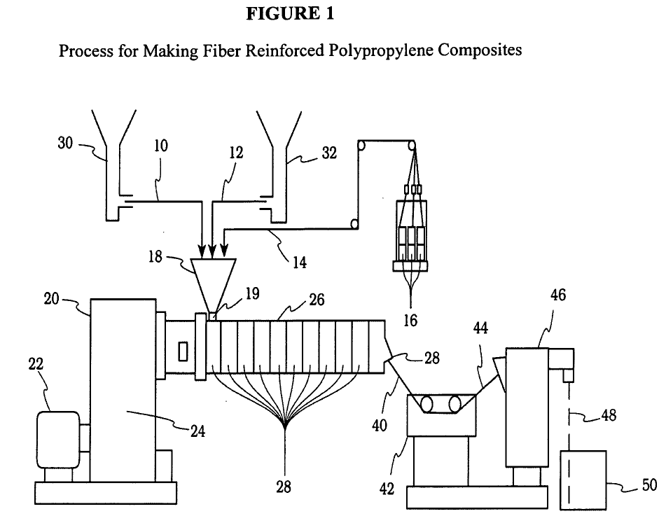

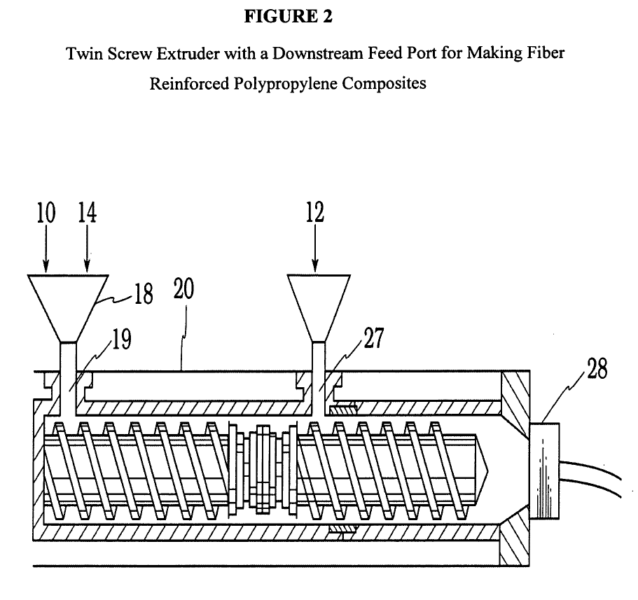

FIG. 1 depicts an exemplary schematic of one form of the process for making PET fiber reinforced polypropylene resin pellets of the present disclosure. Polypropylene based resin 10, inorganic filler 12, and PET fiber 14 continuously unwound from one or more spools 16 are fed into the extruder hopper 18 of a twin screw compounding extruder 20. The extruder hopper 18 is positioned above the feed throat 19 of the twin screw compounding extruder 20. The extruder hopper 18 may alternatively be provided with an auger (not shown) for mixing the polypropylene based resin 10 and the inorganic filler 12 prior to entering the feed throat 19 of the twin screw compounding extruder 20. In an alternative embodiment, as depicted in FIG. 2, the inorganic filler and/or chopped PET fiber 12 may be fed to the twin screw compounding extruder 20 at a downstream feed port 27 in the extruder barrel 26 positioned downstream of the extruder hopper 18 while the remaining components 10, 14 are metered into the extruder hopper 18.

Referring again to FIG. 1, the polypropylene based resin 10 is metered to the extruder hopper 18 via a feed system 30 for accurately controlling the feed rate. Similarly, the inorganic filler 12 is metered to the extruder hopper 18 via a feed system 32 for accurately controlling the feed rate. The feed systems 30, 32 may be, but are not limited to, gravimetric feed system or volumetric feed systems. Gravimetric feed systems are advantageous for accurately controlling the weight percentage of polypropylene based resin 10 and inorganic filler 12 being fed to the extruder hopper 18. The feed rate of PET fiber 14 to the extruder hopper 18 is controlled by a combination of the extruder screw speed, number of fiber filaments and the thickness of each filament in a given fiber spool, and the number of fiber spools 16 being unwound simultaneously to the extruder hopper 18. The higher the extruder screw speed measured in revolutions per minute (rpms), the greater will be the rate at which PET fiber 14 is fed to the twin screw compounding screw 20. The rate at which PET fiber 14 is fed to the extruder hopper also increases with the greater the number of filaments within the organic fiber 14 being unwound from a single fiber spool 16, the greater filament thickness, the greater the number fiber spools 16 being unwound simultaneously, and the rotations per minute of the extruder. With regard to downstream feeding of the inorganic filler and/or chopped organic fiber depicted in FIG. 2, one or more feed systems (not shown) are used for accurately controlling the feed rate of the inorganic filler and/or chopped PET fiber 12 fed to the twin screw compounding extruder 20 at the downstream feed port 27. Again, the feed systems (not shown) may be, but are not limited to, gravimetric feed system or volumetric feed systems.

Referring again the FIG. 1, the twin screw compounding extruder 20 includes a drive motor 22, a gear box 24, an extruder barrel 26 for holding two screws (not shown), and a strand die 28. The extruder barrel 26 is segmented into a number of heated temperature controlled zones 28. As depicted in FIG. 1, the extruder barrel 26 includes a total of ten temperature control zones 28. The two screws within the extruder barrel 26 of the twin screw compounding extruder 20 may be intermeshing or non-intermeshing, and may rotate in the same direction (co-rotating) or rotate in opposite directions (counter-rotating). From a processing perspective, the melt temperature should be maintained above the melting point of the polypropylene based resin 10, and below the melting temperature of the PET fiber 14, such that the mechanical properties imparted by the PET fiber shall be maintained when mixed into the polypropylene based resin 10. In one exemplary embodiment, the barrel temperature of the extruder zones did not exceed 154° C. when extruding PP homopolymer and PET fiber, which yielded a melt temperature above the melting point of the PP homopolymer, but significantly below the melting point of the PET fiber. In another exemplary embodiment, the barrel temperatures of the extruder zones are set at 185° C. or lower.

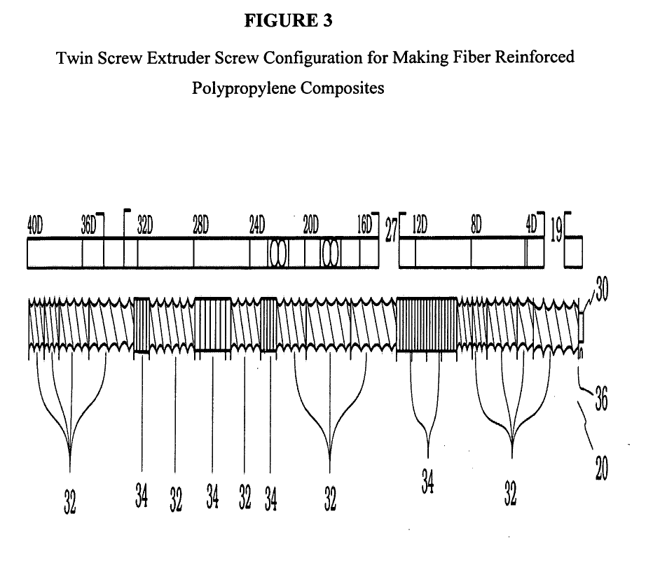

An exemplary schematic of a twin screw compounding extruder 20 screw configuration for making PET fiber reinforced polypropylene resin pellets is depicted in FIG. 3. The feed throat 19 allows for the introduction of polypropylene based resin, PET fiber, and inorganic filler into a feed zone of the twin screw compounding extruder 20. The inorganic filler and/or chopped PET fiber may be optionally fed to the extruder 20 at the downstream feed port 27 of FIG. 2. The twin screws 30 of FIG. 3 include an arrangement of interconnected screw sections, including conveying elements 32 and kneading elements 34. The kneading elements 34 function to melt the polypropylene based resin, cut the PET fiber lengthwise (in particular when fed continuously from one or more spools into the extruder hopper), and mix the polypropylene based melt, cut PET fiber and inorganic filler to form a uniform blend. More particularly, the kneading elements function to break up the PET fiber when fed in continuous for into lengths ranging from 0.2 to 30 mm fiber lengths, or from 0.5 to 25 mm, or from 3 to 19 mm, or from 6 to 14 mm. A series of interconnected kneading elements 34 is also referred to as a kneading block. U.S. Pat. No. 4,824,256 to Haring, et al., herein incorporated by reference in its entirety, discloses co-rotating twin screw extruders with kneading elements. The first section of kneading elements 34 located downstream from the feed throat is also referred to as the melting zone of the twin screw compounding extruder 20. The conveying elements 32 function to convey the solid components, melt the polypropylene based resin, and convey the melt mixture of polypropylene based polymer, inorganic filler and PET fiber downstream toward the strand die 28 (see FIG. 1) at a positive pressure.

The position of each of the screw sections as expressed in the number of diameters (D) from the start 36 of the extruder screws 30 is also depicted in FIG. 3. The extruder screws in FIG. 3 have a length to diameter ratio of 40/1, and at a position 32D from the start 36 of screws 30, there is positioned a kneading element 34. The particular arrangement of kneading and conveying sections is not limited to that as depicted in FIG. 3, however one or more kneading blocks consisting of an arrangement of interconnected kneading elements 34 may be positioned in the twin screws 30 at a point downstream of where organic fiber and inorganic filler are introduced to the extruder barrel. The twin screws 30 may be of equal screw length or unequal screw length. Other types of mixing sections may also be included in the twin screws 30, including, but not limited to, Maddock mixers, and pin mixers.

Referring once again to FIG. 1, the uniformly mixed PET fiber reinforced polypropylene composite melt comprising polypropylene based polymer 10, inorganic filler 12, and PET fiber 14 is metered by the extruder screws to a strand die 28 for forming one or more continuous strands 40 of fiber reinforced polypropylene composite melt. The one or more continuous strands 40 are then passed into water bath 42 for cooling them below the melting point of the fiber reinforced polypropylene composite melt to form a solid fiber reinforced polypropylene composite strands 44. The water bath 42 is typically cooled and controlled to a constant temperature much below the melting point of the polypropylene based polymer. The solid fiber reinforced polypropylene composite strands 44 are then passed into a pelletizer or pelletizing unit 46 to cut them into fiber reinforced polypropylene composite resin 48 into PET fiber reinforced polypropylene based resin pellets. Non-limiting exemplary pelletizers include underwater type pelletizers and strand type pelletizers. In one advantageous process form, a strand pelletizer is used to cut the PET fiber reinforced polypropylene composite into longer resin pellets than may be formed with an underwater type pelletizer. Generally, the number of cutting blades and the speed of the cutting blades in the pelletizer 46 may be used to control the resulting resin pellet length produced. The PET fiber reinforced polypropylene composite resin pellets 48 may then be accumulated in boxes 50, barrels, or alternatively conveyed to silos for storage.

PET fiber reinforced polypropylene composites disclosed herein may be formed into resin pellets using the extrusion compounding and pelletizing processes exemplified in FIGS. 1, 2 and 3. The resin pellets produced in the pelletizer 46 of FIG. 1 may have a length of from 1.0 mm to 25.4 mm. Pellet length is measured using a ruler or other linear measuring device. The lower limit of the resin pellet length may be 1.0 mm, or 2.0 mm, or 3.2 mm, or 4.8 mm, or 6.4 mm, or 8.0 mm, or 9.5 mm. The upper limit of the resin pellet length may be 8.0 mm, or 9.5 mm, or 11.1 mm or 12.7 mm, or 13.9 mm, or 15.0 mm, or 17.0 mm, or 19.1 mm, or 21.0 mm, or 23.0 mm, or 25.4 mm. In one particular embodiment, PET reinforced polypropylene resin pellets may have a pellet length from 3.2 to 12.7 mm, or 6.4 to 9.5 mm. In another particular embodiment, PET reinforced polypropylene resin pellets may have a pellet length from 3.2 to 12.7 mm, or 3.2 to 19.1 mm, or 3.2 to 9.5 mm, or 6.4 to 9.5 mm, or 9.5 to 19.1 mm or 9.5 to 12.7 mm. The optimum resin pellet length range for impact resistance may depend on such exemplary factors as organic fiber type, input organic fiber diameter, organic fiber loading level, input organic fiber length within the fiber reinforced polypropylene melt, method of feeding the organic fiber into the extrusion compounding process (as a chopped or staple fiber or as continuous strands being unwound from spools). In particular, the method of feeding the PET fiber into the extrusion compounding process as a chopped/staple fiber or as continuous strands being unwound from spools may impact the resultant impact resistance of articles molded from the resin pellets. Impact resistance as described herein is measured by the total energy in newton meter to shatter an article molded from the PET fiber reinforced polypropylene resin pellets. Drop dart impact resistance measured via ASTM test method D3763 and was used to establish the relationship between pellet length and impact resistance for both chopped PET fiber and continuous PET fiber feeds. The higher the total energy required to shatter the article, the greater the impact resistance. Generally, the feeding of continuous PET fiber from spools into the twin screw compounding process results in poorer impact resistance than the feeding of ¼″ (6.4 mm long) chopped PET fiber into the extrusion compounding process.

In another embodiment, the PET fiber reinforced polypropylene resin pellets disclosed herein are molded into articles. Articles made from the PET fiber-reinforced polypropylene composite resin pellets described herein include, but are not limited to, automotive parts, household appliances, and boat hulls. Automotive parts include both interior and exterior automobile parts. Cloth-like fiber reinforced polypropylene articles are particularly suitable for interior automotive parts because of the unique combination of toughness, stiffness and aesthetics. More particularly, the non-splintering nature of the failure mode during instrumented impact testing, and the cloth-like look make the cloth-like fiber reinforced polypropylene composites disclosed herein are suited for interior automotive parts, and for interior trim cover panels. Exemplary, but not limiting, interior trim cover panels include steering wheel covers, head liner panels, dashboard panels, interior door trim panels, pillar trim cover panels, and under-dashboard panels. Pillar trim cover panels include a front pillar trim cover panel, a center pillar trim cover panel, and a quarter pillar trim cover panel. Other interior automotive parts include package trays, and seat backs. Articles made from the polypropylene compositions described herein are also suitable for exterior automotive parts, including, but not limited to, bumpers, front end modules, aesthetic trim parts, body panels, under body parts, under hood parts, door cores, and other structural parts of the automobile.

The PET fiber reinforced polypropylene composite resin pellets disclosed herein include, but are not limited to, one or more of the following advantages: an advantageous combination of toughness, stiffness, and aesthetics, improved instrumented impact resistance, improved flexural modulus, improved splinter or shatter resistance during instrumented impact testing, fiber pull out during instrumented impact testing without the need for lubricant additives, ductile (non-splintering) failure mode during instrumented impact testing as opposed to brittle (splintering), a higher heat distortion temperature compared to rubber modified polypropylene, improved part surface appearance from lower inorganic filler loadings, lower part density from lower inorganic filler loadings, a lower flow and cross flow coefficient of linear thermal expansion compared to rubber modified polypropylene, the ability to continuously and accurately feed organic reinforcing fiber into a compounding extruder, reduced production costs and reduced raw material costs, improved part surface appearance, the ability to produce polypropylene fiber composites exhibiting a cloth-like look and/or feel, uniform dispersion of the organic reinforcing fiber and colorant fiber in the composite pellets, improved drop dart impact resistance through tight control of PET fiber reinforced polypropylene resin pellet length, improved impact resistance through the feeding of chopped PET fiber as opposed to continuous PET fiber via spools into the extrusion compounding process, and retention of impact resistance, ductile failure mode and stiffness after the incorporation of colorant with colorant fiber.

The following examples illustrate the present disclosure and the advantages thereto without limiting the scope thereof.

### Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., 25 lbs) is defined as no splintering of the sample.

Drop dart impact test data was generated for injected mold samples produced from the PET fiber reinforced polypropylene resin pellets described herein using ASTM test method D3763 and reported in drop dart impact energy values of newton meter.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

Cimpact CB7 is a surface modified talc, V3837 is a high aspect ratio talc, and Jetfine 700 C is a high surface area talc, all available from Luzenac America Inc. of Englewood, Colo.

### Illustrative Examples 1-8

Varying amounts of PP3505G and 0.25″ (6.4 mm) long polyester fibers were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | wt % | wt % | Total Energy | Instrumented |
|---|---|---|---|---|
| Example # | PP3505G | Fiber | (ft-lbf) | Impact Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | Brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ (6.4 mm) long polyester fibers were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| Example | Impact Conditions/ | Energy | Impact Test |
| # | Applied Energy | (ft-lbf) | Results |

35 wt % PP7805 (70 MFR), 20 wt % talc, 45 wt % fiber

| | | | |
|---|---|---|---|
| 9 | −29° C., 15 MPH, | 16.5 | ductile* |
| | 25 lbs/192 ft-lbf | | |
| 10 | −29° C., 28 MPH, | 14.2 | ductile* |
| | 25 lbs/653 ft-lbf | | |
| 11 | −29° C., 21 MPH, | 15.6 | ductile* |
| | 58 lbs/780 ft-lbf | | |

100 wt % PP8114 (22 MFR)

| | | | |
|---|---|---|---|
| 12 | −29° C., 15 MPH, | 32.2 | ductile* |
| | 25 lbs/192 ft-lbf | | |
| 13 | −29° C., 28 MPH, | 2.0 | brittle** |
| | 25 lbs/653 ft-lbf | | |
| 14 | −29° C., 21 MPH, | 1.7 | brittle** |
| | 58 lbs/780 ft-lbf | | |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit to form a kneading block. The die was ¼″ in diameter. Strands of continuous 27,300 denier PET fibers were fed directly from spools into the hopper of the extruder, along with PP7805 and talc. The kneading elements in the kneading block in the extruder broke up the fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | | | |
|---|---|---|---|---|
| Test | PET fiber-reinforced | | Example 16 | |
| (Method) | PP7805 with talc | | PP8224 | |
| Flexural Modulus, Chord | 525,190 | psi | 159,645 | psi |
| (ISO 178) | | | | |
| Instrumented Impact at −30° C. | 6.8 | J | 27.5 | J |
| Energy to maximum load | | | | |
| 100 lbs at 5 MPH | | | | |
| (ASTM D3763) | | | | |
| Notched Charpy Impact | 52.4 | kJ/m² | 5.0 | kJ/m² |
| at −40° C. | | | | |
| (ISO 179/1eA) | | | | |
| Heat Deflection Temperature | 116.5° | C. | 97.6° | C. |
| at 0.45 Mpa, edgewise | | | | |
| (ISO 75) | | | | |

| | | |
|---|---|---|
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTME831) | | |

### Illustrative Examples 17-18

In Examples 17-18, 30 wt % of either PP3505G or PP8224, 15 wt % 0.25″ (6.4 mm) long polyester fibers, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | | Instrumented Impact |
|---|---|---|---|
| | | | at −30° C. |
| | | | Energy to maximum |
| | | Flexural Modulus, | load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ (6.4 mm) long polyester fibers, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

In examples 19-24, the samples displayed no splintering in drop weight testing at an −29° C., 15 miles per hour at 25 pounds.

### Illustrative Examples 25-26

Two materials, one containing 10% ¼ inch (6.4 mm) polyester fibers, 35% PP3505 polypropylene and 60% V3837 talc (example 25), the other containing 10% ¼ inch (6.4 mm) polyester fibers, 25% PP3505 polypropylene homopolymer (example 26), 10% PO1020 modified polypropylene were molded in a Haake twin screw extruder at 175° C. They were injection molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| Percentage of | | |
|---|---|---|
| Maximum Stress to | Example 25, | Example 26, |
| Yield Point | Cycles to failure | Cycles to failure |
| 70 | 327 | 9848 |
| 80 | 30 | 63 |

The addition of the modified polypropylene is shown to increase the fatigue life of these materials.

### Illustrative Examples 27-29

A Leistritz 27 mm co-rotating twin screw extruder with a ratio of length to diameter of 40:1 was used in these experiments. The process configuration utilized was as depicted in FIG. 1. The screw configuration used is depicted in FIG. 3, and includes an arrangement of conveying and kneading elements. Talc, polypropylene and PET fiber were all fed into the extruder feed hopper located approximately two diameters from the beginning of the extruder screws (19 in the FIG. 3). The PET fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin pellets produced were injection molded and displayed the following properties:

TABLE 7

| | Example 27 | |
|---|---|---|
| Specific Gravity | 1.3 | |
| Tensile Modulus, Chord @ 23° C. | 541865 | psi |
| Tensile Modulus, Chord @ 85° C. | 257810 | psi |
| Flexural Modulus, Chord @ 23° C. | 505035 | psi |
| Flexural Modulus, Chord @ 85° C. | 228375 | psi |
| HDT @ 0.45 MPA | 116.1° | C. |
| HDT @ 1.80 MPA | 76.6° | C. |
| Instrumented impact @ 23° C. | 11.8 | J D** |
| Instrumented impact @ −30° C. | 12.9 | J D** |

**Ductile failure with radial cracks

In example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET fiber were negatively impacted during extrusion compounding such that the PET/PP composite resin had poor instrumented impact test properties.

In example 29, the fiber was fed into a hopper placed 14 diameters down the extruder (27 in the FIG. 3). In this case, the extrudate produced was irregular in diameter and broke an average once every minute as it was pulled through the quenching water bath. When the PET fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester fiber.

The PP composite resin pellets produced while all temperature zones of the extruder were set to 120° C. were injection molded and displayed the following properties:

TABLE 8

| | Example 30 | |
|---|---|---|
| Flexural Modulus, Chord @ 23° C. | 467,932 | psi |
| Instrumented impact @ 23° C. | 8.0 | J D** |
| Instrumented impact @ −30° C. | 10.4 | J D** |

**Ductile failure with radial cracks

### Illustrative Examples 31-34

4% Granite Fleck, which is a masterbatch of dark polymer fiber in a low density polyethylene carrier resin, was extrusion compounded with a twin screw extruder into both polypropylene based impact copolymer (PP 8114) (control sample) and also into a blend of PP homopolymer/PET fiber/talc (40% PP3505G polypropylene, 15% PET reinforcing fiber (¼″ (6.4 mm) length), and 41% Luzenac Jetfine 3CA talc). Corresponding resin samples without the incorporation of the colorant fiber masterbatch (no Granite Fleck) were also produced to assess the impact of the colorant fiber on impact properties for the prior art PP impact copolymer and the PP-PET fiber reinforced composite disclosed herein. The fiber reinforced polypropylene composite without the colorant fiber included 40% PP3505G polypropylene, 15% PET reinforcing fiber (¼″ (6.4 mm) length), and 45% Luzenac Jetfine 3CA talc.

These four resin samples were molded in accordance with the geometry of ASTM D3763 and tested for instrumented impact resistance and failure mode upon impact failure. The instrumented impact test results are given in Table 9.

TABLE 9

| | | | Failure | |
|---|---|---|---|---|
| | | | mode | |
| | | Instru- | during | |
| | | mented | instru- | Flexural |
| Exam- | | impact | mented | modulus |
| ple | Material Composition | (ft-lbs) | impact | (psi) |
| 31 | Impact copolymer (PP | 32.2 | Ductile | No data |
| | 8114) (prior art control w/o | | | |
| | colorant fiber) | | | |
| 32 | Impact copolymer + | 4.1 | Brittle | No data |
| | colorant fiber (PP 8114 + | | | |
| | 4% Granite Fleck) (prior | | | |
| | art control w/colorant fiber) | | | |
| 33 | PP/PET fiber/talc | 11.9 | Ductile | 609,000 |
| | composite (40% PP | | | |
| | 3505G/15% PET fiber/45% | | | |
| | talc) (present disclosure | | | |
| | w/o colorant fiber) | | | |
| 34 | PP/PET fiber/talc/colorant | 12.6 | Ductile | 606,000 |
| | fiber composite (40% PP | | | |
| | 3505G/15% PET fiber/41% | | | |
| | talc/4% Granite Fleck) | | | |
| | (present disclosure + | | | |
| | colorant fiber) | | | |

From Table 9, it is important to note that upon the incorporation of the colorant fiber into the impact polymer (Example 32) of the prior art, there is approximately a 88% decrease in instrumented impact resistance, and also the failure mode goes from ductile (no splintering) to brittle (splintering). In contrast, when colorant fiber is added to the PP/PET fiber/talc composition material (Example 34) of the present disclosure, there is no decrease in instrumented impact resistance, while the failure mode remains ductile in nature, with negligible reduction in flexural modulus. The PP/PET fiber/talc/colorant fiber composite material after molding also has a cloth-like look to it from the incorporation of the dark colorant fiber uniformly dispersed through the molded object. Surprisingly, the PP/PET fiber/talc/colorant fiber composite material (Example 34) retains its outstanding impact resistance unlike the prior art rubber modified PP impact copolymer/colorant fiber sample (Example 32).

### Illustrative Examples 35 and 36

Two processes have been developed to extrude pellets of polyester fiber reinforced polypropylene. One process involves introducing cut PET fiber into the twin screw extruder, while the second involves introducing continuous PET fiber unwound from spools into the extruder hopper of the twin screw extruder, which is then cut in situ in the extruder by the twin screws. The following examples illustrate the effect of PET fiber reinforced polypropylene resin pellet length and process type for introducing PET fiber on the impact properties of the resulting composite. In the case of cut fiber, 15% by weight of 7.1 denier ¼ inch (6.4 mm) long polyester fiber was mixed with 40% high aspect ratio talc (Luzenac Inc.), 40% of an impact copolymer PP 7905 from ExxonMobil Chemical company which has a melt flow rate (mfr) of 90 mfr in accordance with ASTM D1238, and 5% of P01020 from ExxonMobil Chemical Company, a maleic anhydride grafted polypropylene with mfr of 430 in accordance with ASTM D1238. All these materials were dry mixed in a bag and fed through the hopper of a laboratory model Haake extruder run at 200 revolutions per minute, with temperatures at 175° C. across all temperature zones. In the case of continuous fiber cut in situ within the extruder, the extruder was run in accordance with the description of examples 27-29, but with the same composition as described here, and with all zones across the extruder held at 120° C.

The PET reinforced polypropylene composite resins were made into pellet sizes ranging from 3.2 mm to 12.7 mm by varying the pelletizing conditions. For Examples 35 and 36, resin samples were collected for pellet lengths of 3.2, 6.4, 9.5 and 12.7 mm. All samples were subsequently injection molded in a 50 ton Boy machine. All heating zones were held at 401° C., with the mold at 60° C. Total cycle time was 5.1 seconds. For each example and pellet size, dart drop impact energy was measured by determining the total energy to break (in newton meter) via ASTM Test Method D3763. For each process type and pellet length, ten samples were tested. Table 10 below summarizes the total energy to break as a function of PET fiber feed type and pellet length.

The results in Table 10 indicate that the optimum pellet length to attain the highest value of drop dart impact resistance varies depending upon whether continuous PET fiber (Example 35) or chopped PET fiber (Example 36) was fed into the twin screw compounding extruder prior to pelletizing. In the case of input continuous PET fiber, the optimum pellet length was from about 6.4 to 9.5 mm in length and drop dart impact values of 7.9 to 9.6 newton meter were achieved. In the case of input cut PET fiber, the optimum pellet length was from 9.5 mm to 12.7 mm in length and drop dart impact values of 12.9 to 13.4 newton meter were achieved. However, in both cases (continuous and chopped PET fiber input), even PET reinforced polypropylene pellets as small as 3.2 mm in length were sufficient to pass the impact test, defined as no splinters or shards breaking off the sample after impact (ductile failure with radial cracks and no splintering). In addition, the impact data in Table 10 indicates that feeding chopped PET fiber consistently results in higher impact resistance than feeding continuous PET rovings at any given pellet length.

TABLE 10

| | | | | |
|---|---|---|---|---|
| | Total Energy - | | Total Energy - | |
| | Run 1 | | Run 2 | |
| | (Units: ft-lb_{f} | Std | (Units: ft-lb_{f} | Std. |
| Pellet Length | (newton meter)) | Dev. | (newton meter)) | Dev |

Example 35:

| | | | | | | | | | |
|---|---|---|---|---|---|---|---|---|---|
| Continuous | ⅛″ | (3.2 mm) | 5.2 | (7.1) | 2.65 | (3.59) | 4.4 | (6.0) | 1.8 (2.4) |
| Fiber feed | ¼″ | (6.4 mm) | 7.1 | (9.6) | 1.8 | (2.4) | 6.1 | (8.3) | 1.3 (1.8) |
| | ⅜″ | (9.5 mm) | 6.4 | (8.7) | 1.5 | (2.0) | 5.8 | (7.9) | 1.8 (2.4) |
| | ½″ | (12.7 mm) | 5.3 | (7.2) | 2.2 | (3.0) | 3.9 | (5.3) | 0.6 (0.8) |

Example 36:

| | | | | | | | | | |
|---|---|---|---|---|---|---|---|---|---|
| ¼″(6.4 mm) | ⅛″ | (3.2 mm) | 6.9 | (9.4) | 2.1 | (2.8) | 7.2 | (9.8) | 1.7 (2.3) |
| cut fiber feed | ¼″ | (6.4 mm) | 8.6 | (11.7) | 2 | (2.7) | 7.6 | (10.3) | 1.9 (2.6) |
| | ⅜″ | (9.5 mm) | 9.9 | (13.4) | 1 | (1.4) | 9.8 | (13.3) | 0.8 (1.1) |
| | ½″ | (12.7 mm) | 9.8 | (13.3) | 1.1 | (1.5) | 9.5 | (12.9) | 2.5 (3.4) |

### Illustrative Examples 37-55

85% by weight of PP7905 and 15% by weight of 6 denier high tenacity polyester fiber of various pre-cut input fiber lengths (⅛″, ¼″, ½″, and ¾″) were mixed in a Haake twin screw extruder at 175° C. The strand that exited the extruder was cut into various pellet lengths (⅛″, ¼″, ⅜″, ½″, and ¾″) and injection molded using a Boy 50M ton injection molder at 205° C. into a mold held at 60° C. For each input cut fiber length, a sample of the unpelletized extrudate was produced and injection molded as well. Injection pressures and nozzle pressures were maintained at 2300 psi. Samples were molded in accordance with the geometry of ASTM D3763 and tested for instrumented impact at room temperature under the following conditions for interior parts: 25 lbs, at 15 MPH, at 23 C. The total energy absorbed via impact results in foot-pounds force and newton-meter as a function of pellet length and cut-fiber length are given in Table 11 below.

TABLE 11

| Total energy absorbed | | Pellet Length | | | | | | | | | | | |
|---|---|---|---|---|---|---|---|---|---|---|---|---|---|
| (Units: ft-lb_{f} (N-m)) | | ⅛″ | | ¼″ | | ⅜″ | | ½″ | | ¾″ | | | |
| Cut-fiber length | | (3.2 mm) | | (6.4 mm) | | (9.5 mm) | | (12.7 mm) | | (19.1 mm) | | Unpelletized | |
| ⅛″ | (3.2 mm) | 5.6 | (7.6) | 4.5 | (6.1) | 5.5 | (7.5) | 5.4 | (7.3) | 5.8 | (7.9) | 4.7 | (6.4) |
| ¼″ | (6.4 mm) | 6.6 | (8.9) | 7.7 | (10.4) | 4.7 | (6.4) | 7.1 | (9.6) | 5.6 | (7.6) | 6.4 | (8.7) |
| ½″ | (12.7 mm) | 7 | (9.5) | 7.4 | (10.0) | 9.4 | (12.7) | 8.7 | (11.8) | 8.3 | (11.3) | 9 | (12.2) |
| ¾″ | (19.1 mm) | | | | | | | | | | | 9 | (12.2) |

In addition, all the samples (37 to 55) tested for drop dart impact exhibited ductile failures with radial cracks. In other words, none of the samples displayed splintering upon failure. The results also indicate that increased input chopped fiber length results in high impact resistance as 12.7 mm long chopped fiber yielded the highest impact values. When 12.7 mm long chopped fiber is used, the results also indicate that resin pellet lengths of 9.5 to 12.7 mm yielded the highest impact resistance values.

### Illustrative Examples 56 and 57

85% by weight of PP7905 and 15% by weight of 3.1 denier staple tenacity polyester fiber of ¼ inch (3.2 mm) cut fiber length were mixed in a Haake twin screw extruder at 175° C. The strand that exited the extruder was cut into ¼ inch (3.2 mm) pellet lengths and injection molded using a Boy 50M ton injection molder at 205° C. into a mold held at 60° C. A sample of the unpelletized extrudate was also produced and injection molded. Injection pressures and nozzle pressures were maintained at 2300 psi. Samples were molded in accordance with the geometry of ASTM D3763 and tested for instrumented impact at room temperature under the following conditions for interior parts: 25 lbs, at 15 MPH, at 23 C. In addition, the number of samples that did not splinter (# pass) and the number of sample that did splinter (# fail) upon instrumented impact testing were noted and shown below in Table 12. The total energy absorbed during impact testing in foot-pounds force and Newton-meter is also given in Table 12 below.

TABLE 12

| | Impact energy absorbed | |
|---|---|---|
| Sample | (Units: ft-lb_{f}(N-m)) | # pass/#fail |
| ¼″ (6.4 mm) pellet length | 3.3 (4.5) | 4/1 |
| Unpelletized continuous | 3.5 (4.7) | 1/4 |
| extrudate | | |

The results indicate that the low denier (3.1) PET fiber yields poorer impact results compared to higher denier PET fiber (See Examples 35-55). In particular, the impact energy absorbed for the low denier (3.1) PET fiber is lower than the higher denier (6.0 and 7.1 denier) PET fiber of Examples 35-55. In addition, the low denier PET samples exhibited failure (splintering) in one or more samples upon impact testing as compared to no splintering for the higher denier PET fiber samples of Examples 35-55. Hence, a higher loading of PET fiber (20% or more) in the PP matrix polymer is needed to achieve acceptable impact test results when using an input lower denier PET fiber (3.1 denier) as compared to an input higher denier PET fiber (6 and 7.1 denier). It is predicted that a fiber loading of 20% or more of low denier (3.1) PET fiber in a PP matrix polymer should yield impact energies of at least 5.0 newton meter, and possibly at least 5.5 newton meter when smaller pellet sizes are produced for subsequent molding and impact testing.

Applicants have attempted to disclose all embodiments and applications of the disclosed subject matter that could be reasonably foreseen. However, there may be unforeseeable, insubstantial modifications that remain as equivalents. While the present disclosure has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. Polyester fiber reinforced polypropylene resin pellets comprising:
(a) at least 25 wt %, based on the total weight of the composition, polypropylene based polymer;
(b) from 10 to 40 wt %, based on the total weight of the composition, polyester fiber;
(c) from 0 to 60 wt %, based on the total weight of the composition, inorganic filler; and
(d) from 0 to 0.2 wt %, based on the total weight of the composition, lubricant;
wherein the resin pellets range from 3.2 to 12.7 mm in length,
wherein the polyester fiber is incorporated into the resin pellets by continuously feeding PET fiber from one or more spools into the extruder hopper of a compounding extruder, and
wherein an article molded from the resin pellets exhibits a drop dart impact resistance of at least 5.3 newton meter.

2. The polyester fiber reinforced resin pellets of claim 1, wherein the resin pellets range from 6.4 to 9.5 mm in length, and wherein an article molded from the resin pellets exhibits a drop dart impact resistance of at least 7.9 newton meter.

3. The polyester fiber reinforced resin pellets of claim 1, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

4. The polyester fiber reinforced resin pellets of claim 1, wherein the polypropylene based polymer has a melt flow rate of from 20 to 1500 g/10 minutes.

5. The polyester fiber reinforced resin pellets of claim 1, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

6. The polyester fiber reinforced resin pellets of claim 5, wherein the inorganic filler is talc or wollastonite at a loading from 20 to 60 wt %.

7. The polyester fiber reinforced resin pellets of claim 1, wherein the lubricant is chosen from silicon oil, silicon gum, fatty amide, paraffin oil, paraffin wax, ester oil, and combinations thereof.

8. The polyester fiber reinforced resin pellets of claim 1, wherein the input polyester fiber denier is from 5 to 15.

9. The polyester fiber reinforced resin pellets of claim 1, wherein the polypropylene based polymer further comprises from about 0.1 wt % to less than about 10 wt % of a polypropylene based polymer modified with a grafting agent, wherein the grafting agent is chosen from acrylic acid, methacrylic acid, maleic acid, itaconic acid, fumaric acid or esters thereof, maleic anhydride, itaconic anhydride, and combinations thereof.

10. The polyester fiber reinforced resin pellets of claim 1 further comprising from 0.1 to 2.5 wt %, based on the total weight of the composition, colorant fiber, wherein the article molded from the resin pellets exhibits a cloth-like appearance.

11. The polyester fiber reinforced resin pellets of claim 10, wherein the colorant fiber includes an inorganic pigment, an organic dye, or a combination thereof.

12. The polyester fiber reinforced resin pellets of claim 10, wherein the colorant fiber is chosen from cellulosic fiber, acrylic fiber, nylon type fiber, polyester type fiber, and combinations thereof.

13. The polyester fiber reinforced resin pellets of claim 10, wherein the input colorant fiber is from 0.8 mm to 6.4 mm in length.

14. The polyester fiber reinforced resin pellets of claim 10, wherein the polypropylene based polymer further comprises an inorganic pigment, an organic dye, or a combination thereof.

15. The polyester fiber reinforced resin pellets of claim 1, wherein the article is an automotive part, a household appliance part, or a boat hull.

16. The polyester fiber reinforced resin pellets of claim 15, wherein the automotive part is chosen from bumpers, front end modules, aesthetic trim parts, body panels, under body parts, under hood parts, door cores, steering wheel covers, head liner panels, dashboard panels, interior door trim panels, package trays, seat backs, pillar trim cover panels, and under-dashboard panels.

17. Polyester fiber reinforced polypropylene resin pellets comprising:
(a) at least 25 wt %, based on the total weight of the composition, polypropylene based polymer;
(b) from 10 to 40 wt %, based on the total weight of the composition, polyester fiber;
(c) from 0 to 60 wt %, based on the total weight of the composition, inorganic filler; and
(d) from 0 to 0.2 wt %, based on the total weight of the composition, lubricant;
wherein the resin pellets range from 3.2 to 19.1 mm in length,
wherein the polyester fiber is incorporated into the resin pellets by feeding chopped PET fiber into a compounding extruder, and
wherein an article molded from the resin pellets exhibits a drop dart impact resistance of at least 6.1 newton meter.

18. The polyester fiber reinforced resin pellets of claim 1, wherein the resin pellets range from 9.5 to 19.1 mm in length, and wherein an article molded from the resin pellets exhibits a drop dart impact resistance of at least 6.4 newton meter.

19. The polyester fiber reinforced resin pellets of claim 17, wherein the input chopped polyester fiber is from 3.2 to 25.4 mm in length.

20. The polyester fiber reinforced resin pellets of claim 19, wherein the input chopped polyester fiber is from 3.2 to 19.1 mm in length.

21. The polyester fiber reinforced resin pellets of claim 20, wherein the input chopped polyester fiber is from 6.4 to 12.7 mm in length.

22. The polyester fiber reinforced resin pellets of claim 17, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

23. The polyester fiber reinforced resin pellets of claim 17, wherein the polypropylene based polymer has a melt flow rate of from 20 to 1500 g/10 minutes.

24. The polyester fiber reinforced resin pellets of claim 17, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

25. The polyester fiber reinforced resin pellets of claim 24, wherein the inorganic filler is talc or wollastonite at a loading from 20 to 60 wt %.

26. The polyester fiber reinforced resin pellets of claim 17, wherein the lubricant is chosen from silicon oil, silicon gum, fatty amide, paraffin oil, paraffin wax, ester oil, and combinations thereof.

27. The polyester fiber reinforced resin pellets of claim 17, wherein the input polyester fiber denier is from 5 to 15.

28. The polyester fiber reinforced resin pellets of claim 17, wherein the polypropylene based polymer further comprises from about 0.1 wt % to less than about 10 wt % of a polypropylene based polymer modified with a grafting agent, wherein the grafting agent is chosen from acrylic acid, methacrylic acid, maleic acid, itaconic acid, fumaric acid or esters thereof, maleic anhydride, itaconic anhydride, and combinations thereof.

29. The polyester fiber reinforced resin pellets of claim 17 further comprising from 0.1 to 2.5 wt %, based on the total weight of the composition, colorant fiber, and wherein the article molded from the resin pellets exhibits a cloth-like appearance.

30. The polyester fiber reinforced resin pellets of claim 29, wherein the colorant fiber includes an inorganic pigment, an organic dye, or a combination thereof.

31. The polyester fiber reinforced resin pellets of claim 29, wherein the colorant fiber is chosen from cellulosic fiber, acrylic fiber, nylon type fiber, polyester type fiber, and combinations thereof.

32. The polyester fiber reinforced resin pellets of claim 29, wherein the input colorant fiber is from 0.8 mm to 6.4 mm in length.

33. The polyester fiber reinforced resin pellets of claim 29, wherein the polypropylene based polymer further comprises an inorganic pigment, an organic dye, or a combination thereof.

34. The polyester fiber reinforced resin pellets of claim 17, wherein the article is an automotive part, a household appliance part, or a boat hull.

35. The polyester fiber reinforced resin pellets of claim 34, wherein the automotive part is chosen from bumpers, front end modules, aesthetic trim parts, body panels, under body parts, under hood parts, door cores, steering wheel covers, head liner panels, dashboard panels, interior door trim panels, package trays, seat backs, pillar trim cover panels, and under-dashboard panels.

36. A method of making polyester fiber reinforced polypropylene resin pellets comprising:
(a) at least 25 wt %, based on the total weight of the composition, polypropylene based polymer;
(b) from 10 to 40 wt %, based on the total weight of the composition, polyester fiber;
(c) from 0 to 60 wt %, based on the total weight of the composition, inorganic filler; and
(d) from 0 to 0.2 wt %, based on the total weight of the composition, lubricant;
wherein the resin pellets range from 3.2 to 12.7 mm in length,
wherein the polyester fiber is incorporated into the resin pellets by continuously feeding PET fiber from one or more spools into the extruder hopper of a compounding extruder, and
wherein an article molded from the resin pellets exhibits a drop dart impact resistance of at least 5.3 newton meter;
wherein the method comprises:
feeding into the extruder the polypropylene based resin, the polyester fiber, the inorganic filler, and the lubricant;
extruding the polypropylene based resin, the PET fiber, the inorganic filler and the lubricant through the extruder to form a PET fiber reinforced polypropylene composite melt;
cooling and pelletizing the PET fiber reinforced polypropylene composite melt to form the PET fiber reinforced polypropylene resin pellets.

37. The method of claim 36, wherein the resin pellets range from 6.4 to 9.5 mm in length, and wherein an article molded from the resin pellets exhibits a drop dart impact resistance of at least 7.9 newton meter.

38. The method of claim 36, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

39. The method of claim 36, wherein the polypropylene based polymer has a melt flow rate of from 20 to 1500 g/10 minutes.

40. The method of claim 36, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

41. The method of claim 36, wherein the inorganic filler is talc or wollastonite at a loading from 20 to 60 wt %.

42. The method of claim 36, wherein the lubricant is chosen from silicon oil, silicon gum, fatty amide, paraffin oil, paraffin wax, ester oil, and combinations thereof.

43. The method of claim of claim 36, wherein the input polyester fiber denier is from 5 to 15.

44. The method of claim 36, wherein the polypropylene based polymer further comprises from about 0.1 wt % to less than about 10 wt % of a polypropylene based polymer modified with a grafting agent, wherein the grafting agent is chosen from acrylic acid, methacrylic acid, maleic acid, itaconic acid, fumaric acid or esters thereof, maleic anhydride, itaconic anhydride, and combinations thereof.

45. The method of claim 36 further comprising from 0.1 to 2.5 wt %, based on the total weight of the composition, colorant fiber, and wherein the article molded from the resin pellets exhibits a cloth-like appearance.

46. The method of claim 36, wherein the extruder comprises barrel temperature control set points of less than or equal to 185° C.

47. The method of claim 46, wherein the extruder comprises barrel temperature control set points of less than or equal to 165° C.

48. The method of claim 36, wherein the article is an automotive part, a household appliance part, or a boat hull.

49. The method of claim 48, wherein the automotive part is chosen from bumpers, front end modules, aesthetic trim parts, body panels, under body parts, under hood parts, door cores, steering wheel covers, head liner panels, dashboard panels, interior door trim panels, package trays, seat backs, pillar trim cover panels, and under-dashboard panels.

50. A method of making polyester fiber reinforced polypropylene resin pellets comprising:
(a) at least 25 wt %, based on the total weight of the composition, polypropylene based polymer;
(b) from 10 to 40 wt %, based on the total weight of the composition, polyester fiber;
(c) from 0 to 60 wt %, based on the total weight of the composition, inorganic filler; and
(d) from 0 to 0.2 wt %, based on the total weight of the composition, lubricant;
wherein the resin pellets range from 3.2 to 19.1 mm in length,
wherein the polyester fiber is incorporated into the resin pellets by feeding chopped PET fiber into a compounding extruder, and
wherein an article molded from the resin pellets exhibits a drop dart impact resistance of at least 6.1 newton meter;
wherein the method comprises:
feeding into the extruder the polypropylene based resin, the polyester fiber, the inorganic filler, and the lubricant;
extruding the polypropylene based resin, the PET fiber, the inorganic filler and the lubricant through the extruder to form a PET fiber reinforced polypropylene composite melt;
cooling and pelletizing the PET fiber reinforced polypropylene composite melt to form the PET fiber reinforced polypropylene resin pellets.

51. The method of claim 50, wherein the resin pellets range from 9.5 to 19.1 mm in length, and wherein an article molded from the resin pellets exhibits a drop dart impact resistance of at least 6.4 newton meter.

52. The method of claim 50, wherein the input chopped polyester fiber is from 3.2 to 25.4 mm in length.

53. The method of claim 52, wherein the input chopped polyester fiber is from 3.2 to 19.1 mm in length.

54. The method of claim 53, wherein the input chopped polyester fiber is from 6.4 to 12.7 mm in length.

55. The method of claim 50, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

56. The method of claim 50, wherein the polypropylene based polymer has a melt flow rate of from 20 to 1500 g/10 minutes.

57. The method of claim 50, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

58. The method of claim 57, wherein the inorganic filler is talc or wollastonite at a loading from 20 to 60 wt %.

59. The method of claim 50, wherein the lubricant is chosen from silicon oil, silicon gum, fatty amide, paraffin oil, paraffin wax, ester oil, and combinations thereof.

60. The method of claim of claim 50, wherein the input polyester fiber denier is from 5 to 15.

61. The method of claim 50, wherein the polypropylene based polymer further comprises from about 0.1 wt % to less than about 10 wt % of a polypropylene based polymer modified with a grafting agent, wherein the grafting agent is chosen from acrylic acid, methacrylic acid, maleic acid, itaconic acid, fumaric acid or esters thereof, maleic anhydride, itaconic anhydride, and combinations thereof.

62. The method of claim 50 further comprising from 0.1 to 2.5 wt %, based on the total weight of the composition, colorant fiber, and wherein the article molded from the resin pellets exhibits a cloth-like appearance.

63. The method of claim 50, wherein the extruder comprises barrel temperature control set points of less than or equal to 185° C.

64. The method of claim 63, wherein the extruder comprises barrel temperature control set points of less than or equal to 165° C.

65. The method of claim 50, wherein the article is an automotive part, a household appliance part, or a boat hull.

66. The method of claim 65, wherein the automotive part is chosen from bumpers, front end modules, aesthetic trim parts, body panels, under body parts, under hood parts, door cores, steering wheel covers, head liner panels, dashboard panels, interior door trim panels, package trays, seat backs, pillar trim cover panels, and under-dashboard panels.

67. Polyester fiber reinforced polypropylene resin pellets comprising:
(a) at least 25 wt %, based on the total weight of the composition, polypropylene based polymer;
(b) from 20 to 40 wt %, based on the total weight of the composition, polyester fiber, wherein the input polyester fiber denier is less than 5;
(c) from 0 to 60 wt %, based on the total weight of the composition, inorganic filler; and
(d) from 0 to 0.2 wt %, based on the total weight of the composition, lubricant;
wherein the resin pellets range from 3.2 to 25.4 mm in length, and
wherein an article molded from the resin pellets exhibits a drop dart impact resistance of at least 5.0 newton meter.

68. The polyester fiber reinforced resin pellets of claim 67, wherein the resin pellets range from 3.2 mm to 9.5 mm in length, and wherein an article molded from the resin pellets exhibits a drop dart impact resistance of at least 5.5 newton meter.

69. The polyester fiber reinforced resin pellets of claim 67, wherein the polyester fiber is incorporated into the resin pellets by continuously feeding PET fiber from one or more spools into the extruder hopper of a compounding extruder.

70. The polyester fiber reinforced resin pellets of claim 67, wherein the polyester fiber is incorporated into the resin pellets by feeding chopped PET fiber into a compounding extruder.

71. The polyester fiber reinforced resin pellets of claim 69, wherein the input chopped polyester fiber is from 3.2 to 25.4 mm in length.

72. The polyester fiber reinforced resin pellets of claim 70, wherein the input chopped polyester fiber is from 3.2 to 12.7 mm in length.

73. The polyester fiber reinforced resin pellets of claim 67, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

74. The polyester fiber reinforced resin pellets of claim 67, wherein the polypropylene based polymer has a melt flow rate of from 20 to 1500 g/10 minutes.

75. The polyester fiber reinforced resin pellets of claim 67, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

76. The polyester fiber reinforced resin pellets of claim 74, wherein the inorganic filler is talc or wollastonite at a loading from 20 to 60 wt %.

77. The polyester fiber reinforced resin pellets of claim 67, wherein the lubricant is chosen from silicon oil, silicon gum, fatty amide, paraffin oil, paraffin wax, ester oil, and combinations thereof.

78. The polyester fiber reinforced resin pellets of claim 67, wherein the polypropylene based polymer further comprises from about 0.1 wt % to less than about 10 wt % of a polypropylene based polymer modified with a grafting agent, wherein the grafting agent is chosen from acrylic acid, methacrylic acid, maleic acid, itaconic acid, fumaric acid or esters thereof, maleic anhydride, itaconic anhydride, and combinations thereof.

79. The polyester fiber reinforced resin pellets of claim 67 further comprising from 0.1 to 2.5 wt %, based on the total weight of the composition, colorant fiber, and wherein the article molded from the resin pellets exhibits a cloth-like appearance.

80. The polyester fiber reinforced resin pellets of claim 67, wherein the article is an automotive part, a household appliance part, or a boat hull.

81. The polyester fiber reinforced resin pellets of claim 79, wherein the automotive part is chosen from bumpers, front end modules, aesthetic trim parts, body panels, under body parts, under hood parts, door cores, steering wheel covers, head liner panels, dashboard panels, interior door trim panels, package trays, seat backs, pillar trim cover panels, and under-dashboard panels.

82. A method of making polyester fiber reinforced polypropylene resin pellets comprising:
(a) at least 25 wt %, based on the total weight of the composition, polypropylene based polymer;
(b) from 20 to 40 wt %, based on the total weight of the composition, polyester fiber, wherein the input polyester fiber denier is less than 5;
(c) from 0 to 60 wt %, based on the total weight of the composition, inorganic filler; and
(d) from 0 to 0.2 wt %, based on the total weight of the composition, lubricant;
wherein the resin pellets range from 3.2 to 25.4 mm in length, and
wherein an article molded from the resin pellets exhibits a drop dart impact resistance of at least 5.0 newton meter;
wherein the method comprises:
feeding into the extruder the polypropylene based resin, the polyester fiber, the inorganic filler, and the lubricant;
extruding the polypropylene based resin, the PET fiber, the inorganic filler and the lubricant through the extruder to form a PET fiber reinforced polypropylene composite melt;
cooling and pelletizing the PET fiber reinforced polypropylene composite melt to form the PET fiber reinforced polypropylene resin pellets.

83. The method of claim 81, wherein the resin pellets range from 3.2 mm to 9.5 mm in length, and wherein an article molded from the resin pellets exhibits a drop dart impact resistance of at least 5.5 newton meter.

84. The method of claim 81, wherein the polyester fiber is incorporated into the resin pellets by continuously feeding PET fiber from one or more spools into the extruder hopper of a compounding extruder.

85. The method of claim 81, wherein the polyester fiber is incorporated into the resin pellets by feeding chopped PET fiber into a compounding extruder.

86. The method of claim 84, wherein the input chopped polyester fiber is from 3.2 to 25.4 mm in length.

87. The method of claim 85, wherein the input chopped polyester fiber is from 3.2 to 12.7 mm in length.

88. The method of claim 81, wherein the polypropylene based polymer is chosen from polypropylene homopolymers, propylene-ethylene random copolymers, propylene-butene-1 random copolymers, propylene-hexene-1 random copolymers, propylene-octene-1 random copolymers, propylene-α-olefin random copolymers, propylene impact copolymers, ethylene-propylene-butene-1 terpolymers, and combinations thereof.

89. The method of claim 81, wherein the polypropylene based polymer has a melt flow rate of from 20 to 1500 g/10 minutes.

90. The method of claim 81, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

91. The method of claim 89, wherein the inorganic filler is talc or wollastonite at a loading from 20 to 60 wt %.

92. The method of claim 81, wherein the lubricant is chosen from silicon oil, silicon gum, fatty amide, paraffin oil, paraffin wax, ester oil, and combinations thereof.

93. The method of claim 81, wherein the polypropylene based polymer further comprises from about 0.1 wt % to less than about 10 wt % of a polypropylene based polymer modified with a grafting agent, wherein the grafting agent is chosen from acrylic acid, methacrylic acid, maleic acid, itaconic acid, fumaric acid or esters thereof, maleic anhydride, itaconic anhydride, and combinations thereof.

94. The method of claim 81 further comprising from 0.1 to 2.5 wt %, based on the total weight of the composition, colorant fiber, and wherein the article molded from the resin pellets exhibits a cloth-like appearance.

95. The method of claim 81, wherein the extruder comprises barrel temperature control set points of less than or equal to 185° C.

96. The method of claim 94, wherein the extruder comprises barrel temperature control set points of less than or equal to 165° C.

97. The method of claim 81, wherein the article is an automotive part, a household appliance part, or a boat hull.

98. The method of claim 96, wherein the automotive part is chosen from bumpers, front end modules, aesthetic trim parts, body panels, under body parts, under hood parts, door cores, steering wheel covers, head liner panels, dashboard panels, interior door trim panels, package trays, seat backs, pillar trim cover panels, and under-dashboard panels.
